(19) United States
(12) Patent Application Publication
(10) Pub. No.: US 2025/0341861 A1
(43) Pub. Date: Nov. 6, 2025

(54) Case with Display Area

(71) Applicant: Samuel Torres, Brooklyn, NY (US)

(72) Inventor: Samuel Torres, Brooklyn, NY (US)

(21) Appl. No.: 19/189,586

(22) Filed: Apr. 25, 2025

Related U.S. Application Data
(60) Provisional application No. 63/731,485, filed on May 6, 2024.

(51) Int. Cl. G06F 1/16; H04M 1/02

(52) U.S. Cl. CPC G06F 1/1629; H04M 1/0203

(57) ABSTRACT

A case that protects objects such as mobile devices and payment cards that includes a secure display area for displaying items of value such as trading cards.

### BACKGROUND INFORMATION

### Field of the Invention

The invention relates to protective cases that have protective areas to display items of value, and more particularly mobile device cases and card holding wallets.

### Discussion of Prior Art

In recent years, the popularity of collectible trading cards, including sports cards, gaming cards, and other memorabilia, has grown significantly. Collectors often seek innovative ways to display and protect their valuable items while on the go, especially in environments such as conventions, trade shows, or casual meetups where they may wish to show their collection or trade items with others. While some collectors may use individual holders or display cases for such items, there is an increasing desire for more integrated solutions that provide both practicality and visibility.

Mobile phone cases and wallets are ubiquitous accessories for modern smartphone users, offering protection for the device while also serving as a convenient way to carry essential items like credit cards, identification, and cash. However, these products generally lack provisions for displaying or protecting collectible items. Traditional mobile phone cases and wallets are typically designed to shield the phone and personal items from damage, but they do not address the specific needs of collectors who wish to show off or safely store cards or similar objects while using their phone.

There have been efforts to integrate cardholders into mobile phone cases and wallets, but these solutions often fall short in offering adequate protection or visibility for the cards themselves. For example, some cases may provide a compartment for storing cards but lack any transparent or protective element that allows the items to be displayed without risking damage. Additionally, existing card holding wallets may not account for the varying sizes, types, and fragility of collectible items, resulting in potential harm to the objects or a less-than-ideal display of the items.

Thus, there is a need for an improved mobile phone case or wallet that includes an external display area with protective features, designed specifically for displaying trading cards or similarly sized collectible items. Such a case would offer enhanced functionality, allowing users to carry their phone while also safely displaying their valuable items, all while providing the necessary protection against environmental factors such as impacts, scratches, and dirt.

### BRIEF SUMMARY OF THE INVENTION

The present invention is a display case that is configured to hold items of value such as a trading cards, photos, and similar objects, and which may be incorporated into or work in conjunction with a more conventional case such as a mobile device case or a wallet. For example, it may be in the form of a case having a main body that incorporates a durable and secure display area that holds the item of value, with the main body configured in a more conventional manner to alternatively secure and protect a mobile phone or be in the form of a wallet. Ultimately, the invention allows for the protection and display of the item of value on one side of what would otherwise appear to be a conventional and commonly used case.

In one embodiment, where the case is configured to secure a portable electronic device such as a mobile phone, the case is designed to securely hold and display a trading card or similar item, such as a baseball card, while providing protection and accessibility to the mobile phone. The case is uniquely designed to combine the functionality of a standard mobile device protective case with the aesthetic and practical benefits of displaying a collectible item, thereby offering users the ability to personalize their mobile devices while maintaining full protection and usability of the device.

While the specific construction and method of creation may vary, the mobile device case comprises a protective outer shell made from durable materials such as polycarbonate, thermoplastic polyurethane (“TPU”), silicone, or any other material suitable for impact resistance and durability. The case is molded to fit snugly around a mobile device, such as a smartphone, with cutouts or openings for the device's buttons, ports, and camera lens to ensure full accessibility and functionality.

The case includes a recessed area integrated into the back panel of the case, which is specifically sized and shaped to hold and display a trading card or similarly sized item. The recessed area is typically designed to accommodate items with standard dimensions, such as a trading card (e.g., 2.5 inches by 3.5 inches), and is structured to secure the item in place, preventing it from shifting or falling out. The recess may be slightly deeper than the thickness of the trading card to ensure a snug fit and prevent the item from being inadvertently removed.

The recessed area may feature a transparent cover or protective window made of a clear, durable material such as acrylic or polycarbonate. This cover ensures that the trading card is visible while protecting it from damage due to environmental factors, such as dust, moisture, and scratches. The transparent cover is likely formed as an integral part of the device, e.g. as a molded component, or it may be a separate but fixatedly connected component. The recessed area may be entirely enclosed, such that the trading card is sandwiched between the phone and the case, or there may be an opening, such as a narrow slot, in the exterior of the case. For example, a slot may be constructed along the top or along the side of the recessed area, to enable a user to access the card without removing the mobile device. In a case where external access is enabled, additional slots or openings may be provided to enable a user to move cards in or out through the opening.

In many embodiments, it is preferrable if the trading card is first placed into an additional protective member, such as a conventional transparent protective sleeve, prior to being inserted and stored in the recessed area to provide additional protection for the card.

As with conventional cases, the inventive case may be available in various styles, colors, and designs to allow users to further personalize their mobile device. The recessed area may be optionally framed with decorative elements that complement the user's aesthetic preferences, or the nature of the collectible item being displayed. Additionally, the case may offer different configurations, such as a rotating or adjustable display area, to provide different angles of view for the trading card. And, the case may be designed to accommodate a variety of mobile phones and portable electronic devices of different makes and models. The dimensions of the recessed area are adaptable to ensure compatibility with standard trading card sizes, as well as other similarly sized items such as playing cards, photographs, or small artwork.

Another embodiment is directed to a wallet and is of a similar design as the first embodiment whereby the case is similar in construction to a conventional wallet, but has a protective display area on one side of the device where something such as a card may be stored and displayed.

Additionally, in all embodiments, ultraviolet (“UV”) light protection may be added to the case and/or protective sleeves for additional protection to the trading card by adding UV blocking to the transparent widow. The window may also be constructed in various dimensions to display various aspects of the trading card. The case may be of various colors and color designs to match or compliment the aspects of the trading card being displayed. The invention may also be used to protect and display other items of personal or public value where protecting them while simultaneously displaying items is of importance or necessity. The recessed areas may also be constructed to accommodate more than one card. The case may be constructed with additional safety and protective features.

Lastly, in addition to the aforementioned embodiments where the trading card holding compartments are effectively embedded in or constructed as a part of the case itself, the trading card holding compartments may also be standalone units that are connectable to a device or case. For example, a standalone case that protects a card itself with magnets on a side opposite a display area, where the magnets attach the card case to a phone, phone case, or wallet. The standalone case may also be configured to be adhered to a device by, for example, using a common adhesive and/or mechanisms such as hook and loop fasteners.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a plan view of the case according to the invention, configured for a mobile phone, showing the back of the case with a trading card and mobile phone secured in the case.

FIG. 2 is a partial perspective view of the case showing the back and side of the case.

FIG. 3 is a perspective view of the case showing the back, side and end of the case.

FIG. 4A is a perspective view of the case showing the back, side and top of the case.

FIG. 4B is a similar view as 4A, but with an external opening at the top of the recessed area.

FIG. 5 is a perspective view of the case showing the front, side, top and bottom of the case.

FIG. 6 is a side view of the case and a side view of a mobile phone, illustrating the size and shape of the components separated.

FIG. 7 is a perspective view of the case holding a phone showing the side, and front of the case and the front of the phone in the case.

FIG. 8A illustrates a trading card inserted into one type of protective sleeve.

FIG. 8B illustrates a trading card being inserted into a second type of protective sleeve.

FIG. 8C illustrates a trading card in a protective sleeve being inserted into the case.

FIG. 8D illustrates a mobile phone being inserted into a case holding a trading card.

FIG. 9 is a perspective view of a second embodiment of the case showing the front and side of the case.

FIG. 10 is a front view of the second embodiment.

FIG. 11 is a perspective view of the case showing the back, top, and side.

FIG. 12 is a perspective view of the case showing the side, top, and back.

FIG. 13 is a perspective view of the case showing the front, top, and side.

FIG. 14 is a top plan view of the case.

FIG. 15 is an exploded view of the second embodiment of the case.

FIG. 16 is a rear plan view of the case.

FIG. 17 is a front plan view of the case.

FIG. 18 illustrates an embodiment of the case that is magnetically attached to a phone.

FIG. 19 illustrates a magnetic case showing the magnets and without holding an item of value.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

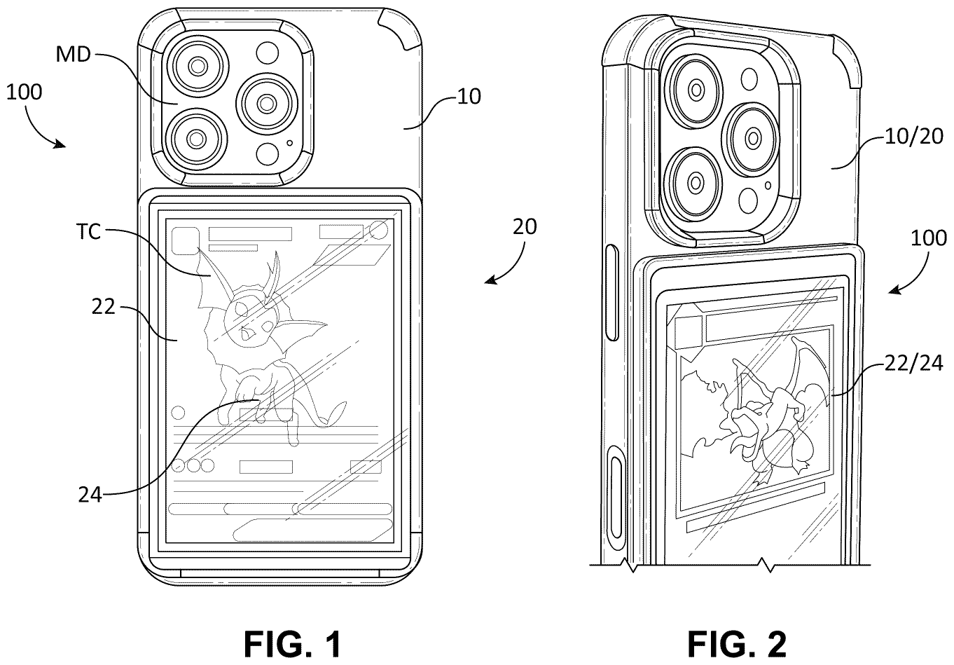

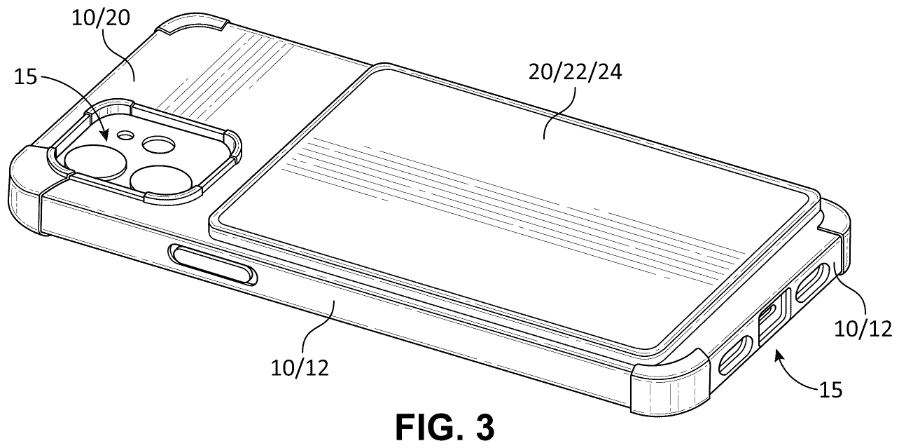

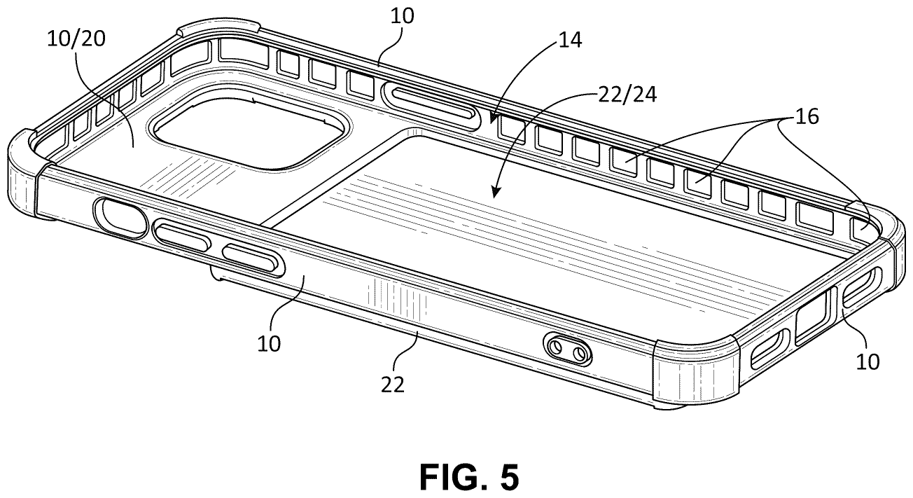

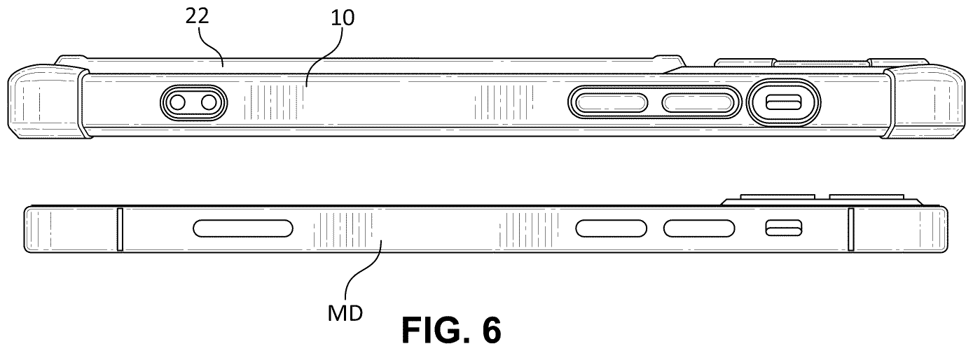

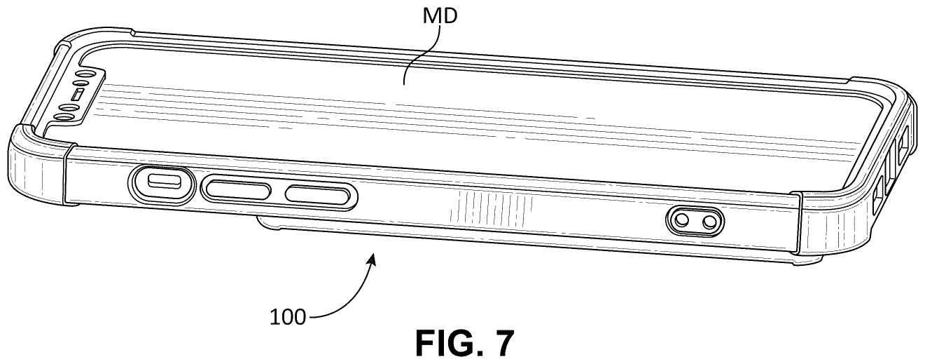

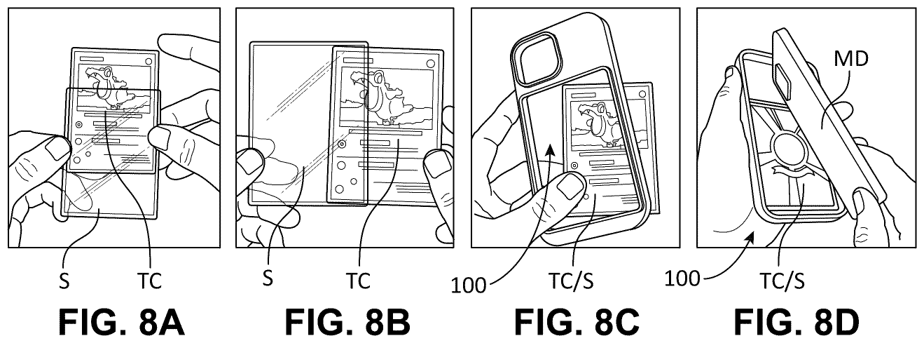

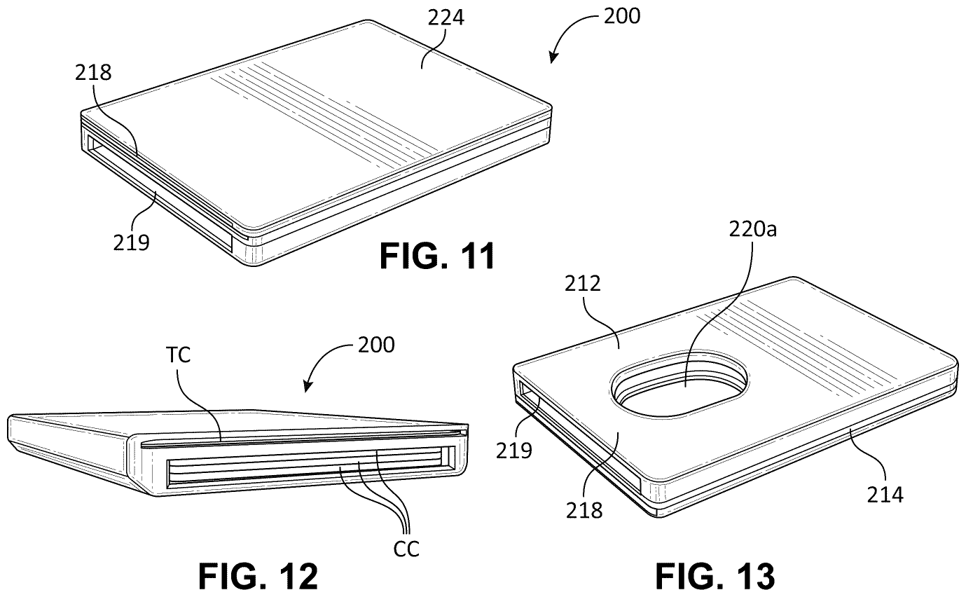

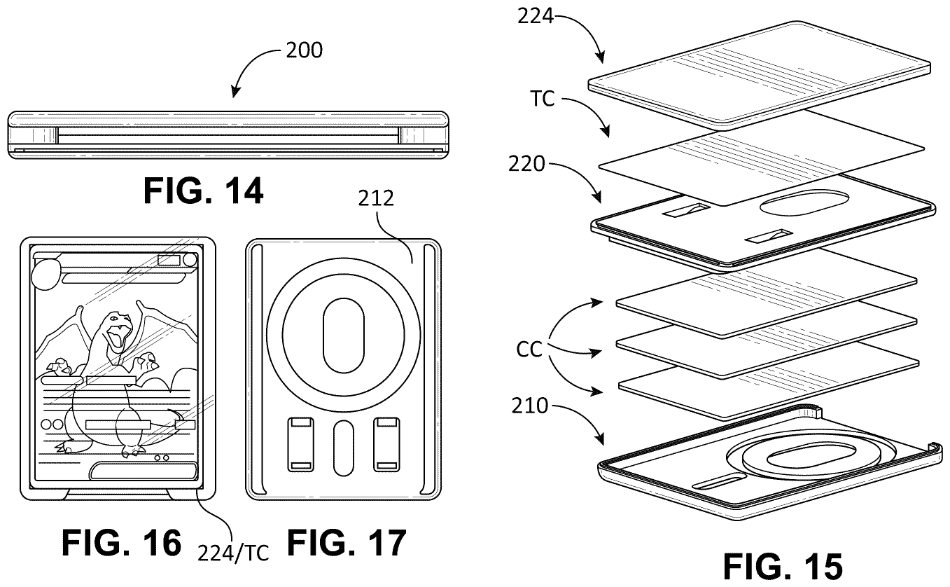

FIGS. 1-19 illustrate a case 100, according to the invention, for securing and displaying an item of value TC.

The first two embodiments include a main body 10 that has a back panel 20, the back panel including a recessed area 22 that is configured to hold the item of value TC. At least a portion of the recessed area 22 is configured as a transparent section 24 so as to allow an item TC contained within the recessed area 22 to be seen through the recessed area 22

FIGS. 1-8 illustrate a first embodiment of the case 100, which is configured to secure a portable electronic device MD such as a mobile phone or tablet. The main body 10 in this embodiment is sized and shaped to secure a conventional mobile phone and is typically designed to conform to the dimensions of the mobile phone, ensuring a snug fit and/or friction fit.

As noted, the recessed area 22 is sized and shaped to hold item of value TC such as a trading card TC. In this example, the case 100 is designed to both secure and protect the trading card TC within the case 100 while also allowing it to be viewed through the case 100. The card TC may be placed directly in the recessed area 22, after which the phone MD may be inserted into the case 100, with the dimensions of the recessed area 22 and the phone MD configured to keep the trading card securely in place. Additionally, the recessed area 22 may be sized to be slightly larger than the conventional trading card TC so that the trading card TC may first be placed into a protective sleeve S, which is then placed in the recessed area 22 and secured by the phone MD. This embodiment also has the advantage of allowing the card TC to be easily swapped for another by simply removing the phone MD from the case 100, replacing the card TC, and reinserting the phone MD.

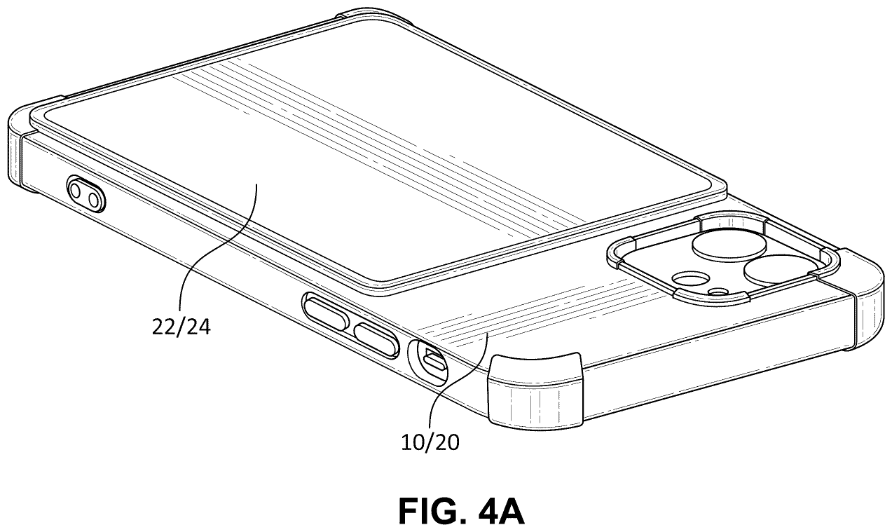

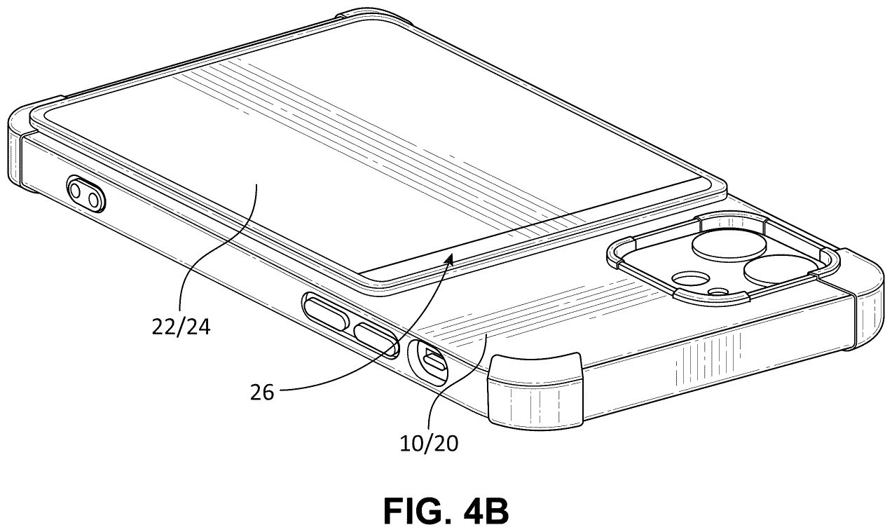

The case 100 is generally composed of a rigid or semi-rigid material, such as plastic, polycarbonate, or a flexible material like silicone or rubber. The main body 10 is designed to cover the back, sides, and corners of the phone, offering protection against impact from accidental drops and bumps. The transparent section 24 of the recessed area 22 may also be made of, or otherwise include, ultraviolet (UV) light protection, which may be provided in the material itself or as an added layer that is applied or affixed to the transparent area. The recessed area may also have an opening 26, an example of which is illustrated in FIG. 4B, to allow for an item TC to be inserted and/or removed without removing the phone MD.

Side walls 12 of the case surround the sides of the mobile phone MD, extending from the back panel 20 toward the front of the mobile phone MD. The side walls 12 are designed to offer shock absorption and to protect the phone's edges from potential damage. In some instances, the side walls 12 may have a raised lip that provides additional protection to the phone's screen, ensuring that the screen is not in direct contact with surfaces when placed face down. An inner side 14 of the sidewalls 12 may also include extension pockets 16 that create additional width in the case without sacrificing the overall fit of the case on the device. For example, each pocket may be between 0.1 mm in depth 0.5 mm in depth, with a depth of 0.3 mm being particularly advantageous with most mobile devices. The main purpose of these pockets 16 is to expand the width of that recessed area in such a way that the protection of the device is not sacrificed, nor is the accessibility of any buttons, e.g. volume, power, and mute switch, etc. Without this extra width in the inner walls, it is impractical to create a recessed area in the case that is able to accommodate the width of a standard size trading card and a protective sleeve.

The case 100 is also likely to include cutouts 15 or openings 15 to accommodate the phone's functional components, such as: a camera lens, where a precise cutout allows access to the phone's camera lens, ensuring that the camera is unobstructed and remains fully operational; a charging port and/or headphone jack, which include openings that are strategically placed to provide access to the charging port, headphone jack, and any other necessary connectors without the need to remove the case; volume and power buttons, which in some cases are placed in the side walls may include raised buttons or buttons that are embedded into the case to allow users to operate the phone's volume and power buttons; and speaker and microphone cutouts, which may also be included for speaker and microphone access, ensuring the phone's sound output and input are not blocked by the case.

The case may be made using a number of conventional materials, which may vary depending on the desired level of protection, durability, and aesthetic appeal. Common materials include:
Plastic (Polycarbonate, TPU): These are durable and rigid materials that offer a lightweight, non-bulky case design while providing protection against scratches, drops, and impacts. Silicone/Rubber: Soft, flexible materials that provide shock absorption and a comfortable grip, offering excellent protection against drops and scratches.
Leather: Often used for premium cases, leather provides a stylish and luxurious finish while offering moderate protection.
Metal: Some high-end mobile phone cases feature metal components, offering durability and a premium feel while also enhancing the phone's appearance.

The process of manufacturing a conventional mobile phone case typically involves injection molding, thermoforming, or die-cutting techniques. The material is shaped into the desired form, with cutouts for the phone's buttons, ports, and camera. The case is then finished with additional treatments like polishing, coating, or texturing to improve grip, durability, and aesthetics.

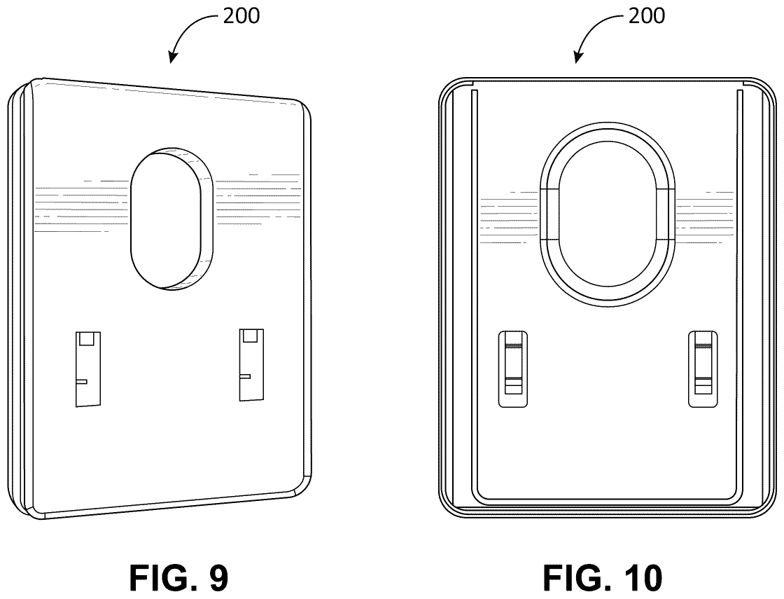

FIGS. 9-17 illustrate a second embodiment 200 of the case, in the form of a wallet. As with the first embodiment, the case includes a main body 210 that has a back panel 220, the back panel 220 having a transparent cover 224 that allows an item of value, such as a trading card TC to be seen through the case 200. The wallet illustrated in the figures is comprised of a ridged material, and is particularly well adapted to hold credit cards CC. It includes a front panel 212, side panels 214, a bottom panel 216 and a top panel 218, with the top panel having an opening 219 to allow for the insertion of monetary objects such as credit cards CC.

FIG. 15 illustrates an exploded view of one manner in which this embodiment 200 may be constructed, which includes the main body 210, the back panel 220, and a card cover 224. The main body 210 and back panel 220 are secured to one another to form an area to hold credit cards CC, a trading card TC may be placed against an outer side of the back panel 220, and then the card cover 230 may be placed over the card TC to secure it in place against the case 200. In this illustration, the various components are molded to create a snap-fit, however, it may be formed in a number of manners including being molded as a single unit or being formed from multiple components that are connected to one another using one of more fasteners and/or adhesives.

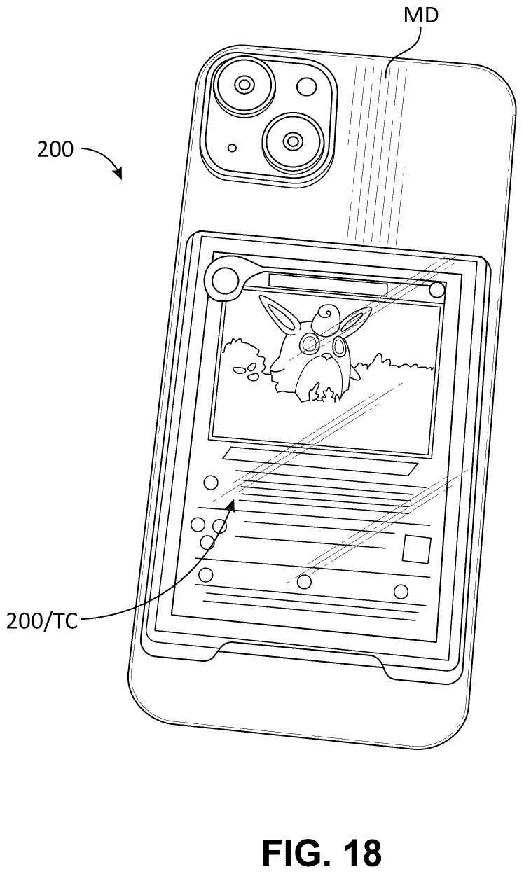

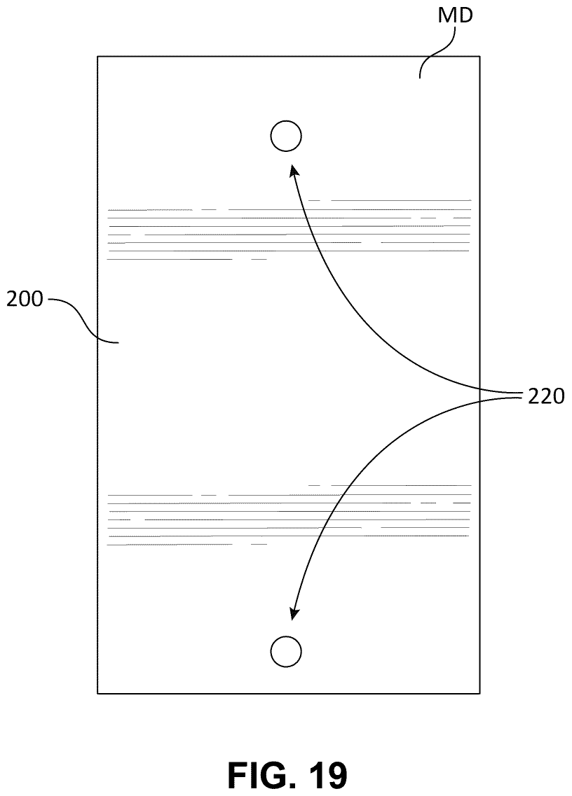

FIGS. 18 and 19 illustrate a third embodiment, in which a card holder 200 is configured to be attached to a device such as a phone or phone case. The holder 200 in this embodiment is a molded and/or hardened plastic container that is transparent at least on a majority of one side so as to allow the item TC to be viewed through the holder 200, and has an opening on the side or top to allow an item to be inserted and removed. FIG. 19 illustrates the holder 200 without an item and with a pair of magnets 220 that are affixed to the holder 200 and that enable a connection between the holder 200 and a device such as a mobile phone MD or a wallet. The holder may also be applied to a mobile phone or wallet with other types of fasteners such as hook and loop fasteners or with various suitable adhesives.

It is understood that the embodiments described herein are merely illustrative of the present invention. Variations in the case may be contemplated by one skilled in the art without limiting the intended scope of the invention herein disclosed.

1: A mobile device case adapted to hold a mobile device and display an item of value, the mobile device case comprising:
a main body configured to enclose the mobile device, the main body including a sidewall and a back panel;
the back panel including an exterior surface, the exterior surface including a recessed area defined by a perimeter wall and a base surface, the recessed area dimensioned to securely hold the item of value substantially flush with or below the exterior surface of the back panel;
the recessed area's base surface having a transparent area that is configured to allow visible access to the item of value; and
the main body configured to secure the item of value in the recessed area between the base surface and the mobile device.

2: The case of claim 1, wherein the recessed area is formed as a molded part of the main body.

3: The case of claim 1, wherein the main body is configured to form a friction fit with the mobile device and item of value.

4: The case of claim 1, wherein the transparent area comprises ultraviolet light protection.

5: The case of claim 1, wherein the recessed area is sized to hold a trading card.

6: The case of claim 1, wherein the recessed area is sized to hold a trading card that is placed inside a protective sleeve.

7: The case of claim 1, wherein the recessed area is sized to hold multiple trading cards.

8: (canceled)

9: (canceled)

10: (canceled)

11: (canceled)

12: (canceled)

13: (canceled)

14: (canceled)

15: A case for a portable electronic device, the case comprising:
a main body configured to receive and retain the portable electronic device, the main body including a back panel;
and a means for holding and displaying a trading card in the back panel,
wherein the means for securing includes a recessed area in the back panel, the recessed area being sized and shaped to receive the item of value and being configured to retain the item by contact with a mobile device received in the main body.

16: The case of claim 15, wherein at least a portion of the recessed area includes a transparent section configured to allow the item of value to be viewed through the back panel.

17: The case of claim 16, wherein the transparent section includes ultraviolet (UV) light protection.

18: The case of claim 15, wherein the recessed area is dimensioned to receive a trading card enclosed in a protective sleeve.

19: The case of claim 15, wherein the item of value is secured within the recessed area by insertion of a mobile device into the main body, such that a surface of the mobile device engages the item of value and retains it within the recessed area.
